(19) United States
(12) Patent Application Publication
(10) Pub. No.: US 2017/0085396 A1
(43) Pub. Date: Mar. 23, 2017

(54) DYNAMIC SMOOTHING BASED ON CHANNEL FLATNESS DETECTION

(71) Applicant: QUALCOMM Incorporated, San Diego, CA (US)

(72) Inventors: Zixia HU, Sunnyvale, CA (US); Kai SHI, San Jose, CA (US); Chin-Hung CHEN, San Jose, CA (US)

(21) Appl. No.: 14/861,345

(22) Filed: Sep. 22, 2015

(51) Int. Cl. H04L 25/02; H04L 5/00; H04W 72/04; H04W 24/08

(52) U.S. Cl. CPC H04L 25/0204; H04W 24/08; H04L 5/0007; H04W 72/0453

(57) ABSTRACT

Systems and methods for wireless communications are disclosed. More particularly, aspects generally relate to techniques for wireless communications by an apparatus comprising receiving a packet via a wireless channel, determining a parameter indicative of frequency selectivity of the channel, selecting a smoothing filter based on the parameter; and applying the smoothing filter to process at least one portion of the packet.

### BACKGROUND

Field of the Disclosure

Certain aspects of the present disclosure generally relate to wireless communications and, more particularly, to dynamic smoothing based on channel flatness detection.

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDM/OFDMA) networks, and Single-Carrier FDMA (SC-FDMA) networks.

Channel smoothing may be utilized to provide noise reduction in OFDM/OFDMA networks. In low delay, spread, flat fading channels, channel responses on adjacent subcarriers are highly correlated and smoothing can provide a significant noise reduction benefit and enhance channel response coherency in adjacent subcarriers. However, smoothing filter designs are a tradeoff between mitigating channel estimation error while avoiding distorting the channel response.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Each of various implementations of systems, methods, and devices within the scope of the appended claims has one or more aspects and no single aspect is solely responsible for desirable attributes described herein. Without limiting the scope of the appended claims, certain features are described herein. In view of this discussion, and, particularly of the “Detailed Description,” one will understand how features of various aspects allow generating and transmitting, by a device, such as an access point, a frame that indicates both minimum and maximum bandwidths for communication in a network. Furthermore, one will understand how various aspects allow determining, by a device, such as a user equipment, both minimum and maximum bandwidths for communicating in the network based on a frame received from the access point.

Aspects of the present disclosure provide an apparatus for wireless communications. The apparatus generally includes an interface configured to obtain a packet transmitted via a wireless channel and a processing system configured to determine a parameter indicative of frequency selectivity of the channel, selecting a smoothing filter of the apparatus based on the determined parameter, and apply the smoothing filter to process at least one portion of the packet.

Aspects of the present disclosure provide a method for wireless communications by an apparatus. The method generally includes receiving a packet via a wireless channel, determining a parameter indicative of frequency selectivity of the channel, selecting a smoothing filter based on the parameter, and applying the smoothing filter to process at least one portion of the packet.

Aspects of the present disclosure provide an apparatus for wireless communications. The apparatus generally includes means for receiving a packet via a wireless channel, means for determining a parameter indicative of frequency selectivity of the channel, means for selecting a smoothing filter based on the parameter, and means for applying the smoothing filter to process at least one portion of the packet.

Aspects of the present disclosure provide a computer readable medium for wireless communications having instructions stored thereon. The instructions are generally executable by a processing system for obtaining a packet via a wireless channel, determining a parameter indicative of frequency selectivity of the wireless channel, selecting a smoothing filter based on the determined parameter, and applying the smoothing filter to process at least one portion of the packet.

Aspects of the present disclosure provide a wireless node. The wireless node generally includes at least one antenna configured to receive a wireless signal, a receiver configured to receive, via the at least one antenna, a packet via a wireless channel, and a processing system generally configured to determine a parameter indicative of frequency selectivity of the wireless channel, select a smoothing filter based on the determined parameter, and apply the smoothing filter to process at least one portion of the packet.

Certain aspects also provide various methods, apparatuses, and computer program products capable of performing operations corresponding to those described above.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example packet that may be processed, in accordance with certain aspects of the present disclosure.

FIG. 5 illustrates a block diagram of example operations for wireless communications by an apparatus, in accordance with certain aspects of the present disclosure.

FIG. 5A illustrates example means capable of performing the operations shown in FIG. 5.

FIG. 6 illustrates a block diagram of example apparatus that may perform dynamic smoothing, in accordance with certain aspects of the present disclosure.

FIGS. 7A and 7B illustrate example performance differences that may be obtained with and without dynamic smoothing filters applied, in accordance with certain aspects of the present disclosure.

### DETAILED DESCRIPTION

Aspects of the present disclosure provide techniques that may improve system performance by dynamically selecting smoothing filters used to refine channel estimations. For example, a smoothing filter may be selected based on frequency selectivity of a wireless channel. In other words, different smoothing filters (with different smoothing coefficients) may be better suited for different applications depending on frequency selectivity. For example, a more aggressive filter (with a flatter smoothing response with a smaller delay time) may be more suitable for when a channel response exhibits relatively flat fading. As another example, if the channel response is more frequency selective (non-flat fading), a more conservative filter or filter setting may be applied.

As used herein, the term fading generally refers to the deviation of attenuation affecting a wireless signal over the propagation media. The fading may vary with time, geographical position or frequency. Fading may be due to different factors, such as multipath propagation (in which a receiver sees the superposition of multiple copies of the transmitted signal, each traversing a different path) or due to shadowing from obstacles affecting the wave propagation.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems. An OFDMA system uses orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may use interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

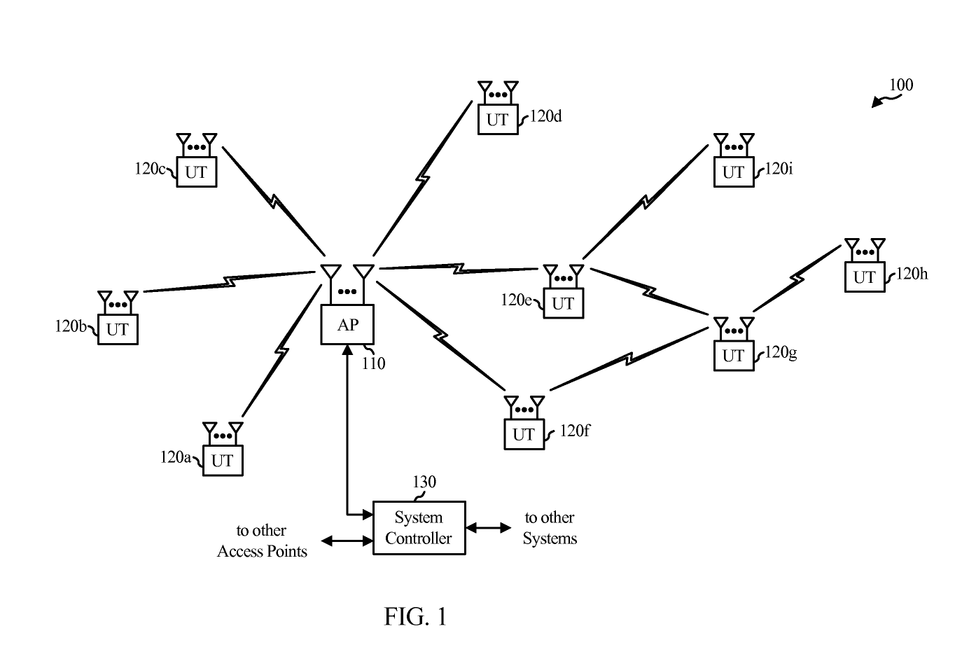

FIG. 1 illustrates a system 100 in which aspects of the disclosure may be performed. For example, the access point 110 or user terminal 120 may determine whether another access point 110 or user terminal 120 is capable of receiving a paging frame (e.g., an ultra low-power paging frame) via a second radio (e.g., a companion radio), while a first radio (e.g., a primary radio) is in a low-power state. The access point 110 or user terminal 120 may generate and transmit the paging frame comprising a command field (e.g., a message ID field) that indicates one or more actions for the other access point 110 or user terminal 120 to take.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 may couple to and provide coordination and control for the access point.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also use a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

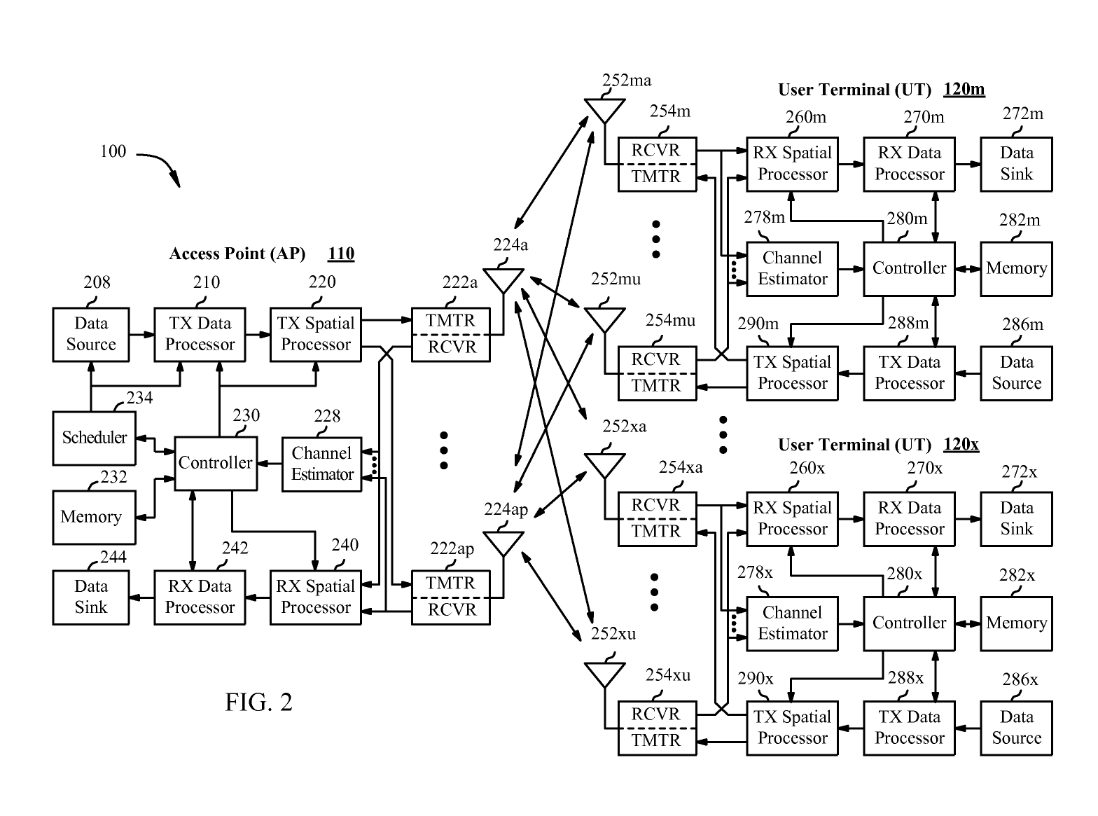

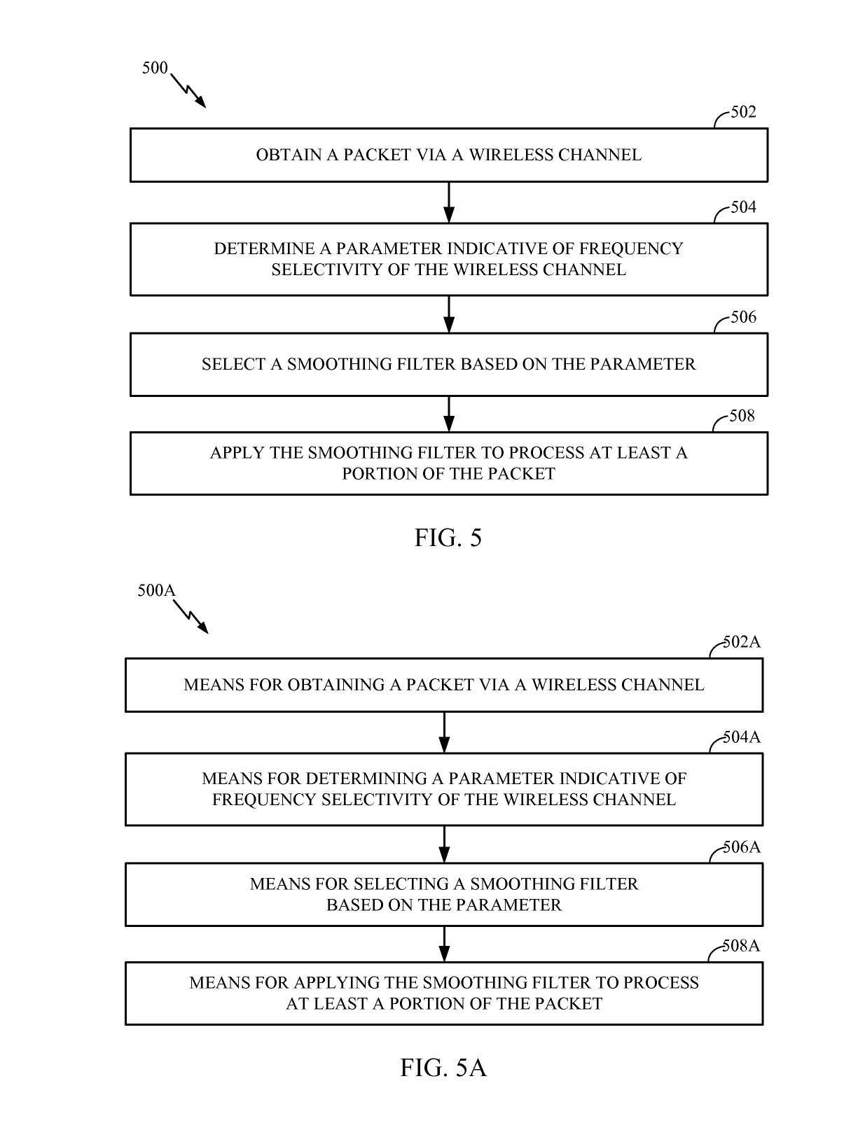

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 may be used to perform the operations described herein and illustrated with reference to FIGS. 17-18A. Similarly, antenna 252, Tx/Rx 254, processors 260, 270, 288, and 290, and/or controller 280 of the UT 120 may be used to perform the operations described herein and illustrated with reference to FIGS. 5-5A.

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while N_{dn} user terminals are simultaneously transmit on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 208 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

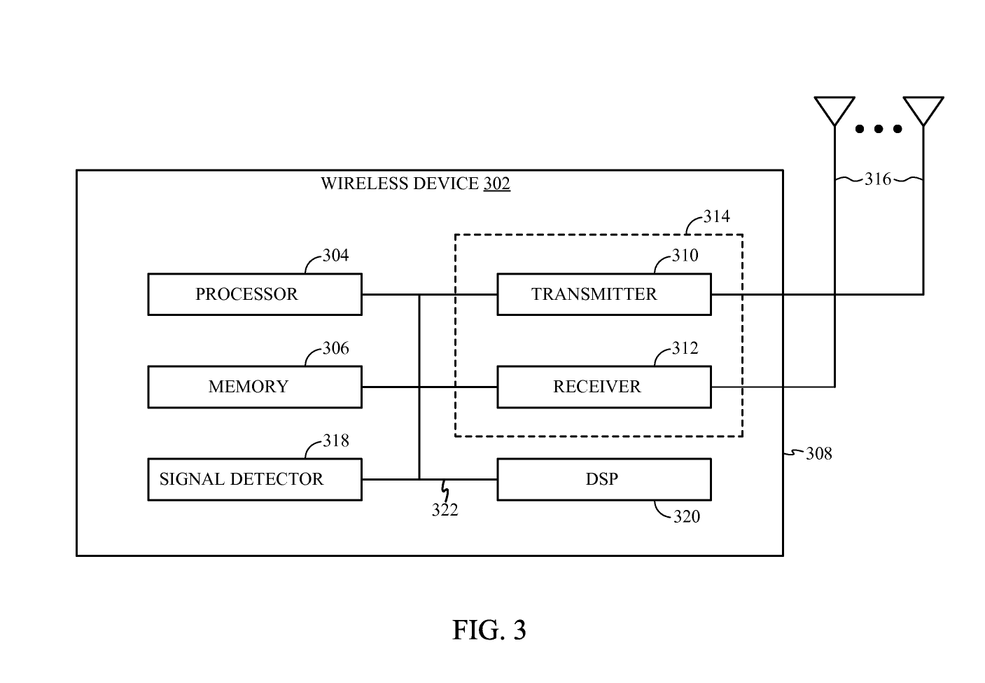

FIG. 3 illustrates example components that may be utilized in the AP 110 and/or UT 120 to implement aspects of the present disclosure. For example, the transmitter 310, antenna(s) 316, processor 304 and/or the DSP 320 may be used to practice aspects of the present disclosure implemented by the AP. Further, the receiver 312, antenna(s) 316, processor 304 and/or the DSP 320 may be used to practice aspects of the present disclosure implemented by the UT.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Dynamic Smoothing Based on Channel Flatness Detection

As noted above, aspects of the present disclosure provide techniques that may improve system performance by dynamically selecting smoothing filters used to refine channel estimations.

Generally, wireless signals fade and different frequency components of a signal generally fade differently. A coherence bandwidth of a channel indicates the amount of separation in frequency two signals may have before experiencing uncorrelated fading. A channel in which the coherence bandwidth of the channel is less than the channel bandwidth experiences frequency selective (“non-flat”) fading where different frequency components of the signal experience uncorrelated fading.

Conversely, in a “flat fading” channel, the coherence bandwidth of the channel is greater than the bandwidth of the channel signal. In this manner, flatness may refer to the relationship of the coherence bandwidth of a channel to the channel bandwidth. That is, in a flat fading channel, the frequency components of the signal generally experience the same magnitude of fading. Thus in a low delay, spread, flat fading channel, channel response on adjacent subcarriers are highly correlated. Applying channel smoothing to such a channel can provide a significant noise reduction benefit.

In many cases, a smoothing filter may be used (e.g., at a receiving station) to refine a channel estimate and generate a refined channel estimate. Smoothing filters generally are designed to balance mitigating channel estimate (CE) error while not distorting the channel response. For example, a fixed smoothing filter may be designed to handle effectively the worst case channel spread delay (CSD) and delay spread (e.g., which may be up to 600 ns). However, such conservative smoothing filters may not offer as much sensitivity and benefit for known CSD or for an additive white Gaussian noise (AWGN) channel that may be offered by a more aggressive smoothing filter or smoothing filter setting.

In order to improve the performance of smoothing, aspects of the present disclosure provide a dynamic smoothing algorithm that selects from multiple smoothing filters, for example, based on different flatness thresholds. According to certain aspects, a smoothing filter may be selected by adjusting the smoothing coefficients of a configurable filter. As an alternative (or in addition), a smoothing filter may be selected from different smoothing filters, by actually enabling a different filter (or routing signals to a different filter).

A smoothing filter may be selected based, for example, on a detected channel flatness, which may be compared to a pre-defined flatness threshold. A channel flatness level may be determined based on the channel estimate results from the high-throughput or very high throughput long training field (HT/VHT LTF). The HT/VHT-LTF consists of a defined sequence of symbols based on the number of transmitted streams and may occur (e.g. occurring in the packet) prior to one or more data fields.

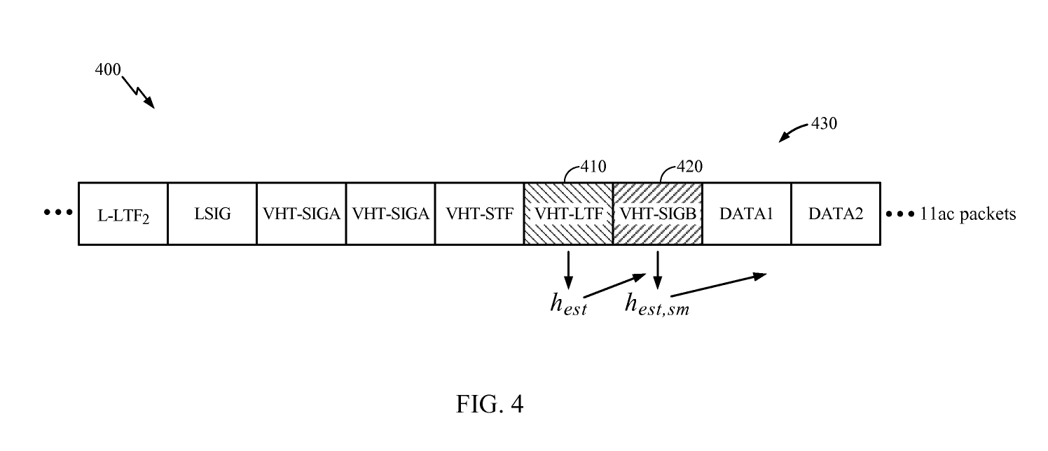

FIG. 4 illustrates an example packet 400 (or wireless frame), in which dynamic smoothing may be applied, in accordance with certain aspects of the present disclosure. The packet 400, may correspond to an 802.11ac VHT packet which may include a VHT-LTF 410, a VHT-SIGB field 420, and one or more data fields 430 (which may collectively referred to as a data portion) that may be processed using a channel estimate (CE) generated based on the VHT-LTF 410 and VHT-SIGB field 420.

For example, an initial (or raw, unfiltered) CE may be calculated based on the VHT-LTF 410. This CE may be used to determine a power ratio of different frequency bins which may be used as a flatness parameter indicative of frequency selectivity of the channel during the duration of the VHT-LTF field 410.

Based on the detected channel flatness, a particular smoothing filter from a set of smoothing filters may be selected. The selected smoothing filter may then be applied to the initial CE to generate a refined CE. This refined CE may be used to process the data portion of the packet 400. As will be described below, in some cases, a refined CE may be used to process the first data field in the data portion. In other cases, the refined CE may be used to process one or more later symbols.

Channel estimation may be performed on a sequence of symbols across the transmitted streams to determine the channel response. For example, a power ratio may be determined based on the CE calculated for the training fields (HT/VHT LTF) by analyzing receive power measurements for the sequence of symbols across different frequency bins. The power ratio, R, may be defined as

$$R = R = \frac{{\overline{P}}_{max\_bin}}{{\overline{P}}_{min\_bin}} ,$$

where P̅ₘₐₓ_{_}_{bin} is the average power of the first N max power bins and P̅ₘᵢₙ_{_}_{bin} is the average power of the first N min power bins. This power ratio may then be compared to one or more flatness thresholds and a smoothing filter coefficient selected based on the comparison.

For example, a power ratio less than the flatness threshold may indicate that the channel response is relatively flat fading and a more aggressive smoothing filter or filter setting may be applied. Where the power ratio is greater than the flatness ratio, the channel response is more frequency selective, a more conservative filter or filter setting may be applied. Ranges may also be defined correlating power ratio ranges with smoothing filters.

Referring again to FIG. 4, during the duration of the VHT-SIGB field 420, a smoothing coefficient may be selected based on the channel flatness detection. For example, the smoothing filter selected during the VHT-LTF may be applied to the initial CE to further refine the CE. This refined CE may be used, for example, to select a smoothing coefficient of a smoothing filter, to vary how aggressively the filter is applied.

As noted above, the selected filter (with corresponding smoothing coefficients) may then be applied to process the data portion. For example, the selected filter and smoothing coefficient may be applied to the first data field following the VHT-SIGB. Where the VHT-SIGB does not exist, such as for 802.11n packets, the CE may be determined based on the VHT-LTF or HT-LTF field, the smoothing coefficient may be selected during the duration of the first data field after the VHT-LTF or HT-LTF, and the refined CE may be applied starting from the second data field.

FIG. 5 illustrates example operations 500 for processing a packet using dynamic smoothing, according to certain aspects of the disclosure. The operations 500 may be applied to any type of frame including a HT or VHT LTF frames. The operations 500 may be performed by an apparatus, such as a UT 120 as illustrated in FIGS. 1 and 2, or the wireless device 302 illustrated in FIG. 3.

The operations 500 begin at 502 by obtaining a packet via a wireless channel. At 504, the apparatus determines a parameter indicative of frequency selectivity of the wireless channel. At 506, the apparatus selects a smoothing filter based on the determined parameter. At 508, the apparatus applies the smoothing filter to process at least one portion of the packet.

As noted above, in some cases, the at least one portion of the packet may be a data portion and the smoothing filter may be applied to one or more data fields of the data portion.

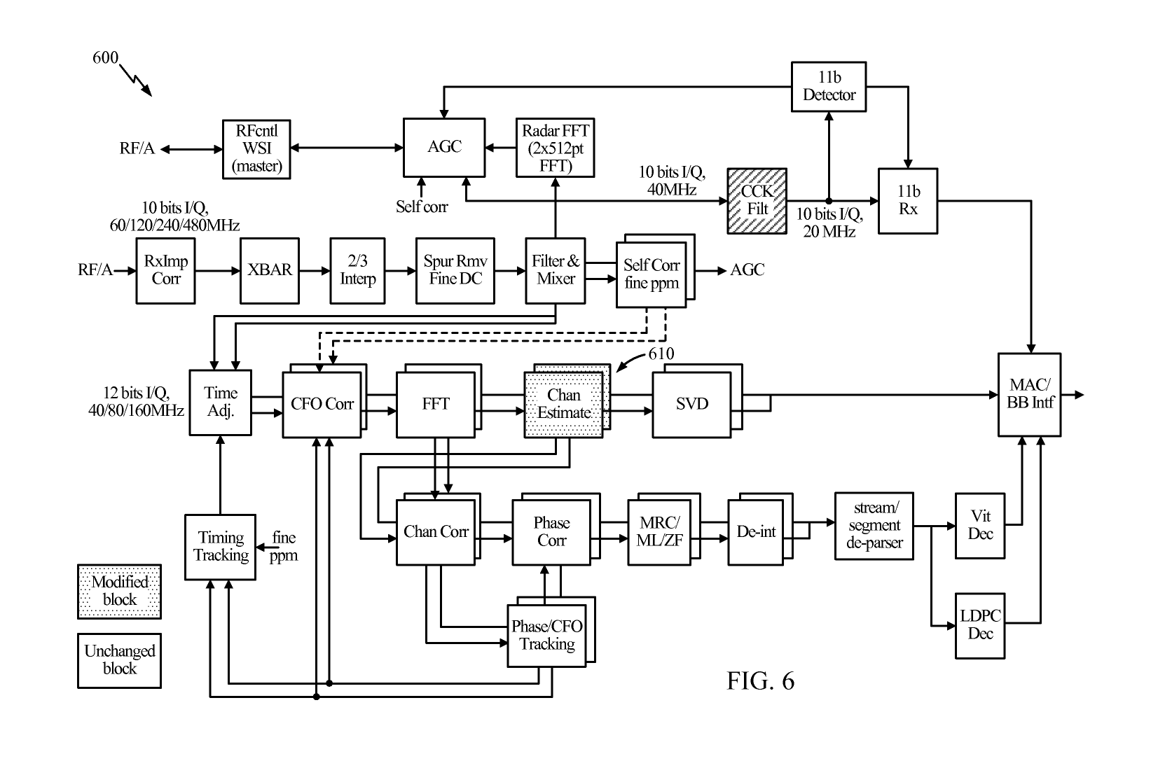

FIG. 6 illustrates a block diagram of example apparatus 600 which may be configured to process packets using dynamic smoothing, in accordance with certain aspects of the present disclosure. The apparatus 600 may correspond, for example, to a receiver in a device that processes 802.11 AC packets. In such cases, the dynamic smoothing described herein may be implemented in a channel estimate block 610 of the receiver. As noted above, such a block may be configured to generate a refined CE using a smoothing filter dynamically selected, for example, based on flatness of the channel as determined by an initial CE.

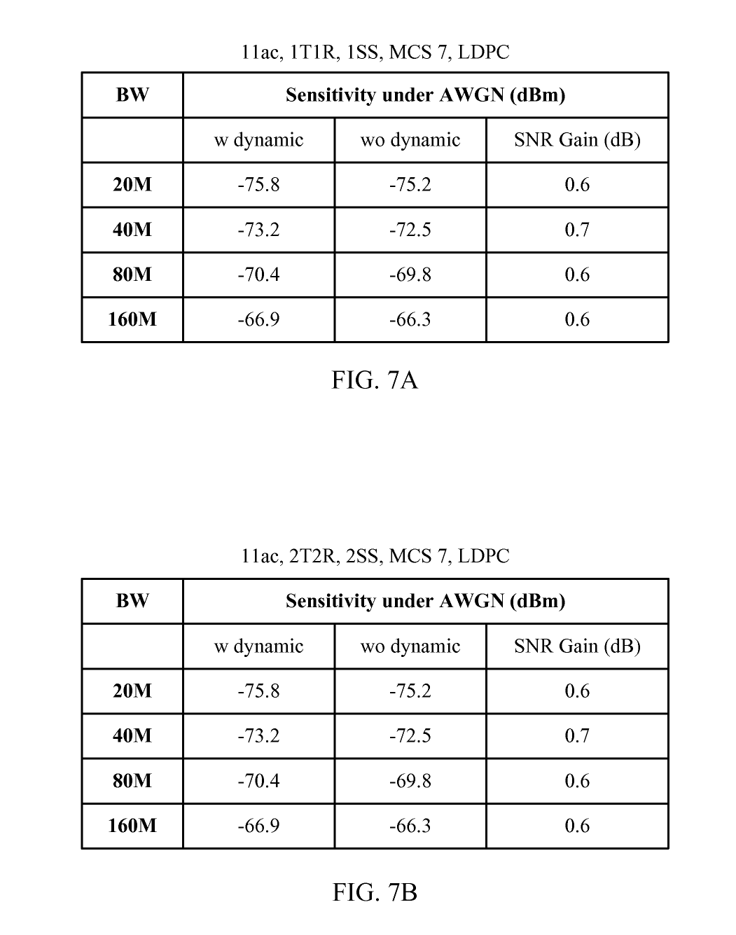

FIGS. 7A and 7B illustrate example performance differences that may be obtained with and without dynamic smoothing filters applied, in accordance with certain aspects of the present disclosure.

In FIG. 7A, the potential SNR gain for a 802.11AC system with one transmitter and one receiver on one system simulator modulation and coding scheme 7 and with a low-density parity check. In FIG. 7B, the potential SNR gain for an 802.11AC system with two transmitters and two receivers is shown. In both cases, the system is simulated with dynamic smoothing as against a fixed +−600 ns smoothing coefficient at various bandwidths (BW) with dynamic smoothing enabling up to a 0.7 dB SNR gain.

As illustrated, with channel smoothing enabled, the received signal may exhibit a SNR gain. This SNR gain may be quantized for the received signal, y=hx+n by estimating the transmitted signal as

$$\hat{x} = \frac{y}{\hat{h}} .$$

### Substituting,

$$\hat{x} = \frac{y}{\hat{h}} = \frac{hx + n}{h + {n}_{h}} = \frac{( hx + n ) ( h - {n}_{h} )}{( h + {n}_{h} ) ( h - {n}_{h} )} = \frac{{h}^{2} \cdot x + n \cdot h - h \cdot x \cdot {n}_{h} - n \cdot {n}_{h}}{{h}^{2} - {n}_{h}^{2}} .$$

To simplify the expression, we can assume that all variables are real and that h and x are normalized to 1, and thus \hat{x}≈1+n=nₕ. The SNR estimation then is

$$SNR = \frac{1}{{σ}^{2} + {σ}_{h}^{2}} .$$

With channel smoothing enabled, the effective SNR becomes

$${SNR}_{sm = 1} = \frac{1}{{σ}^{2} + α \cdot {σ}_{h}^{2}} ,$$

where α·σₕ² is the residual CE error variance after smoothing and α is the smoothing gain.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 in FIG. 5 may correspond to means 500A illustrated in FIG. 5A.

Means for obtaining (e.g., receiving) may comprise a receiver (e.g., the receiver unit 254) and/or an antenna(s) 252 of the UT 120 illustrated in FIG. 2 or the receiver 312 and/or antenna(s) 316 depicted in FIG. 3. Means for generating, means for detecting, means for determining, means for obtaining, means for selecting, means for refining, means for processing, and/or means for applying may include a processing system, which may include one or more processors such as processors 260, 270, 288, and 290 and/or the controller 280 of the UT 120 or the processor 304 and/or the DSP 320 portrayed in FIG. 3.

According to certain aspects, such means may be implemented by processing systems configured to perform the corresponding functions by implementing various algorithms (e.g., in hardware or by executing software instructions) described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer readable storage medium with instructions stored thereon separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be used.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
an interface configured to obtain a packet transmitted via a wireless channel; and
a processing system configured to:
determine a parameter indicative of frequency selectivity of the wireless channel;
select a smoothing filter based on the determined parameter; and
apply the smoothing filter to process at least one portion of the packet.

2. The apparatus of claim 1, wherein the processing system is configured to select the smoothing filter from a plurality of smoothing filters having different smoothing coefficients.

3. The apparatus of claim 1, wherein:
the at least one portion of the packet comprises a data portion; and
the processing system is configured to determine the parameter based on a training field occurring in the packet prior to the data portion.

4. The apparatus of claim 3, wherein the processing system is configured to:
obtain a first channel estimate based on the training field;
refine the first channel estimate based on the selected smoothing filter to obtain a refined channel estimate; and
process one or more data fields of the data portion based on the refined channel estimate.

5. The apparatus of claim 3, wherein the processing system is configured to:
obtain a first channel estimate based on the training field; and
determine the parameter based on the first channel estimate.

6. The apparatus of claim 5, wherein the processing system is configured to select the smoothing filter based on a comparison of the parameter to one or more threshold values.

7. The apparatus of claim 3, wherein the processing system is configured to determine the parameter based on a ratio of received power measurements for a sequence of symbols in the training field across different frequency bins.

8. The apparatus of claim 1, wherein:
the at least one portion of the packet comprises a data portion; and
the processing system is configured to apply the smoothing filter starting at a first occurring data field of the data portion.

9. A method for wireless communications by an apparatus, comprising:
obtaining a packet via a wireless channel;
determining a parameter indicative of frequency selectivity of the wireless channel;
selecting a smoothing filter based on the determined parameter; and
applying the smoothing filter to process at least one portion of the packet.

10. The method of claim 9, wherein the smoothing filter is selected from a plurality of smoothing filters having different smoothing coefficients.

11. The method of claim 9, wherein:
the at least one portion of the packet comprises a data portion; and
the parameter is determined based on a training field occurring in the packet prior to the data portion.

12. The method of claim 11, further comprising:
obtaining a first channel estimate based on the training field;
refining the first channel estimate based on the selected smoothing filter to obtain a refined channel estimate; and
processing one or more data fields of the data portion based on the refined channel estimate.

13. The method of claim 11, further comprising:
obtaining a first channel estimate based on the training field; and
wherein the parameter is determined based on the first channel estimate.

14. The method of claim 13, wherein the smoothing filter is selected based on a comparison of the parameter to one or more threshold values.

15. The method of claim 11, wherein the parameter is determined based on a ratio of received power measurements for a sequence of symbols in the training field across different frequency bins.

16. The method of claim 9, wherein
the at least one portion of the packet comprises a data portion; and
applying the smoothing filter to process at least one portion of the packet comprises applying the smoothing filter starting at a first occurring data field of the data portion.

17. An apparatus for wireless communications, comprising:
means for obtaining a packet via a wireless channel;
means for determining a parameter indicative of frequency selectivity of the wireless channel;
means for selecting a smoothing filter based on the determined parameter; and
means for applying the smoothing filter to process at least one portion of the packet.

18. The apparatus of claim 17, wherein the means for selecting comprises means for selecting the smoothing filter from a plurality of smoothing filters having different smoothing coefficients.

19. The apparatus of claim 17, wherein:
the at least one portion of the packet comprises a data portion; and
means for determining comprises means for determining the parameter is determined based on a training field occurring in the packet prior to the data portion.

20. The apparatus of claim 19, further comprising:
means for obtaining a first channel estimate based on the training field;
means for refining the first channel estimate based on the selected smoothing filter to obtain a refined channel estimate; and
means for processing one or more data fields of the data portion based on the refined channel estimate.

21-26. (canceled)
